(19) United States
(12) Patent Application Publication
(10) Pub. No.: US 2004/0157571 A1
(43) Pub. Date: Aug. 12, 2004

(54) Enhanced register based FSK demodulator

(76) Inventors: Klaas Wortel, Phoenix, AZ (US); Luis J. Briones, Chandler, AZ (US)

Correspondence Address: Jeffrey C. Hood, Meyertons, Hood, Kivlin,, Kowert & Goetzel PC, P.O. Box 398, Austin, TX, 78767, US

(21) Appl. No.: 10/361,041

(22) Filed: Feb. 7, 2003

(51) Int. Cl. H04B 1/00; H04L 27/22

(52) U.S. Cl. 455/131; 375/324

(57) ABSTRACT

Quadrature I and Q signals, which may be generated by a direct conversion radio receiver, are demodulated using an FSK demodulator. The FSK demodulator uses limiter amplifiers to generate rail-to-rail square wave versions of the I and Q signals, which are then selectively connected to data and clock inputs of a register bank comprised of D flip-flops. The outputs of the D flip-flops are polled by a majority vote detector which provides as its output the demodulated modulating bitstream. The FSK demodulator requires no complex analog circuitry and no processing power from a baseband DSP. The FSK demodulator demodulates a modulating bitstream at a minimum modulating index of df/fm>1.

### BACKGROUND OF THE INVENTION

1. Field of the Invention

This invention relates generally to the field of wireless equipment design and, more particularly, to radio frequency (RF) modulator and demodulator design.

2. Description of the Related Art

The wireless world has become increasingly digitally oriented, leading Radio Frequency (RF) based design work to feature prominently in the scope of today's digital communications design. One effect of this development has been the prominence achieved by the development of modulators and demodulators, which provide a necessary RF interface for systems such as cordless phones, wireless networks, and wireless peripheral devices for computers, such as cordless mice, keyboards, etc.

One commonly used modulation method is “quadrature modulation”, which employs two carriers out of phase by 90° and modulated by separate signals. There are also many digital encoding standards that allow for the transmission of vast amounts of data over wireless RF interfaces in shorter periods of time. One well-known digital encoding technique based on frequency modulation (FM) is frequency shift keying (FSK), which in its simplest form provides two discrete RF frequencies that can be used as carriers to transmit two data states, which may correspond to the commonly used digital binary states of “1” and “0”, respectively.

Spectral efficient modulation accommodates more data traffic within a limited bandwidth and implies a lower modulation index. In order for low cost wireless equipment to make use of the available spectrum (limited bandwidth), it is preferred to employ spectral efficient modulation techniques. In many cases however, highly spectral efficient modulation schemes may require highly complicated RF modulators and demodulators, which could lead to inefficient designs at high costs. In most high-end systems where ample digital signal processing (DSP) power is available in the baseband processing, generally the I and Q signals get sampled in an Analog to Digital Converter after some basic filtering is performed. Therefore, the demodulation process may take place entirely inside the DSP, in the digital domain. For example, cell phones may generally apply such methods. Modulation indexes of less than 1 are easily achievable in such environments. In less sophisticated systems however, a DSP may not be present in the baseband, and thus the demodulator function would have to be implemented in the analog domain.

In the analog domain, a demodulator may typically employ a four quadrant mixer/multiplier and a phase shifting network. While there may be no modulation index restrictions on such circuit, in most cases a mixer/multiplier would have to be integrated, and the phase shifting network would typically be external and constructed with bulky and expensive components that may require trimming.

Therefore, it may be advantageous to focus on a simple form of demodulation using D flip-flops (DFF), as a possible basis for implementing an FSK demodulator. One example of a use of a single DFF in paging receivers at quadrature base band has been discussed in “Fully Integrated Radio Paging Receiver” by I. A. W. Vance, IEE Proceedings vol. 129, Part F, no1, pp. 2-6, February 1982. A simple single DFF paging implementation may effectively solve the issue of FSK demodulation. However, one major drawback might be the necessity of keeping the modulation index high (>2) in order for the demodulator to work properly

FIG. 1 illustrates a direct conversion radio receiver (DCRR) 100 implemented in accordance with prior art. An antenna 102 is operable to receive a modulated radio frequency (RF) signal, which is then amplified by a low-noise amplifier (LNA) 104. The amplified modulated RF signal is down converted into quadrature I-channel (I) 122 and Q-channel (Q) 120 signals with the aid of a quadrature voltage controlled oscillator (VCO) 110 and mixers 106 and 108. The output of 106 and the output of 108 may both be filtered through low pass filters 112 and 114, respectively, thus producing I 122 and Q 120. The filtering may be performed in order to suppress adjacent channels and bring other band interfering noise down to acceptable levels. I 122 and Q 120 are used as inputs to an FSK demodulator, which is employed to precisely recreate a modulating bitstream used to modulate the RF carrier signal.

FIG. 2 shows a single DFF FSK demodulator built in accordance with prior art. Q 120 and I 122 from DCRR 100 are connected to limiter amplifiers 202 and 204, respectively. The limiter amplifiers provide high gain amplification and convert Q 120 and I 122 into square waves QSQ 210 and ISQ 212, respectively. QSQ 210 is provided as the D input of DFF 206, and ISQ 212 is provided as the clock input of DFF 206. Since modulation information is contained in the edges of Q 120 and I 122, not in the amplitude thereof, it is possible to generate rail-to-rail square waves with the use of the limiter amplifiers, insuring proper operation of DFF 206. Output Q of DFF 206 provides demodulated output (DO) 208, which represents the modulating bitstream embedded in I 122 and Q 120.

FIG. 3 contains waveform diagrams for signals Q 120, I 122, QSQ 210, and ISQ 212, as pertaining to the DFF FSK demodulator in FIG. 2. Waveforms 302, 304, 306 and 308 illustrate a behavior of Q 120, I 122, QSQ 210 and ISQ 212, respectively, when DO 208 is 0. Waveforms 310, 312, 314 and 316 illustrate a behavior of Q 120, I 122, QSQ 210 and ISQ 212, respectively, when DO 208 is 1. As FIG. 3 illustrates, the FSK demodulator in FIG. 2 demodulates the modulated RF signal without errors. DFF 206 is triggered on a rising edge of ISQ 212. In order to perform precise demodulation of a modulating bitstream using the FSK demodulator illustrated in FIG. 2, a single DFF, as shown, requires at least one rising edge on the C input of DFF 206 per duration. In order to assure one positive edge per bit, at least one full sine wave is required per bit. A minimum modulation index (df/fm) required for the single DFF FSK demodulator to precisely demodulate a modulating bitstream is therefore >2, where “df” represents the peak frequency deviation from the carrier frequency, and “fm” stands for the maximum modulation frequency of the modulating bitstream (or one-half the bitrate). In paging receivers this may not be of concern as a high modulation index is already required and defined within the standard. For other wireless equipment employing a considerably lower modulation index for spectral efficiency, a more suitable method may be required.

### SUMMARY OF THE INVENTION

In one set of embodiments, the invention comprises a system and method that provides digital FSK demodulation employed in obtaining a modulating bitstream, using registers. In one embodiment, the system comprises a pair of limiter amplifiers, a register bank, and a majority vote detector. A Q signal and an I signal, which may be received from a direct conversion radio receiver, may each be coupled to an input of a respective limiter amplifier. The register bank may comprise D flip-flops (DFF). The DFFs may be divided into a first set of DFFs and a second set of DFFs.

In one embodiment, an output of the first limiter amplifier representing the Q signal is coupled to a respective data input of each DFF in the first set of DFFs and to a respective clock input of each DFF in the second set of DFFs. Similarly, an output of the second limiter amplifier representing the I signal may be coupled to a respective data input of each DFF in the second set of DFFs and to a respective clock input of each DFF in the first set of DFFs. An output of each DFF may be connected to a respective input of the majority vote detector. In one embodiment, the majority vote detector is used to perform baseband filtering, where an output of the majority vote detector provides a baseband signal representing a modulating bitstream carried in the Q and I signal.

A radio receiver system may be designed using an FSK demodulator implemented in accordance with one set of embodiments of the present invention. The radio receiver system may include an antenna coupled to an LNA, a frequency down converter stage (FDCS), and a set of low pass filters. The LNA may be coupled to the FDCS, which may comprise a quadrature VCO, and a set of mixers. In one embodiment, an output of each mixer is connected to an input of a respective low pass filter, with an output of a first low pass filter providing a Q signal and an output of a second low pass filter providing an I signal. The Q signal and I signal may be connected to respective inputs of the FSK demodulator.

Thus, various embodiments of the invention may provide a means for register based FSK demodulation performed without complex analog circuitry and without requiring processing power from a baseband digital signal processor (DSP), consuming minimal power, and performing baseband filtering through hysteresis while precisely demodulating a modulating bitstream at a minimum modulation index of df/fm>1.

### BRIEF DESCRIPTION OF THE DRAWINGS

The foregoing, as well as other objects, features, and advantages of this invention may be more completely understood by reference to the following detailed description when read together with the accompanying drawings in which:

FIG. 1 illustrates one embodiment of a direct conversion radio receiver, in accordance with prior art;

FIG. 2 illustrates one embodiment of a single DFF-based FSK demodulator, in accordance with prior art;

FIG. 3 contains a set of waveform diagrams illustrating a behavior of signals I, Q, D and C from FIG. 2, in accordance with prior art;

FIG. 4 illustrates a block diagram of a DFF-based FSK demodulator implemented in accordance with one set of embodiments of the present invention;

FIG. 5 illustrates a more detailed diagram of the DFF-based demodulator in FIG. 4.

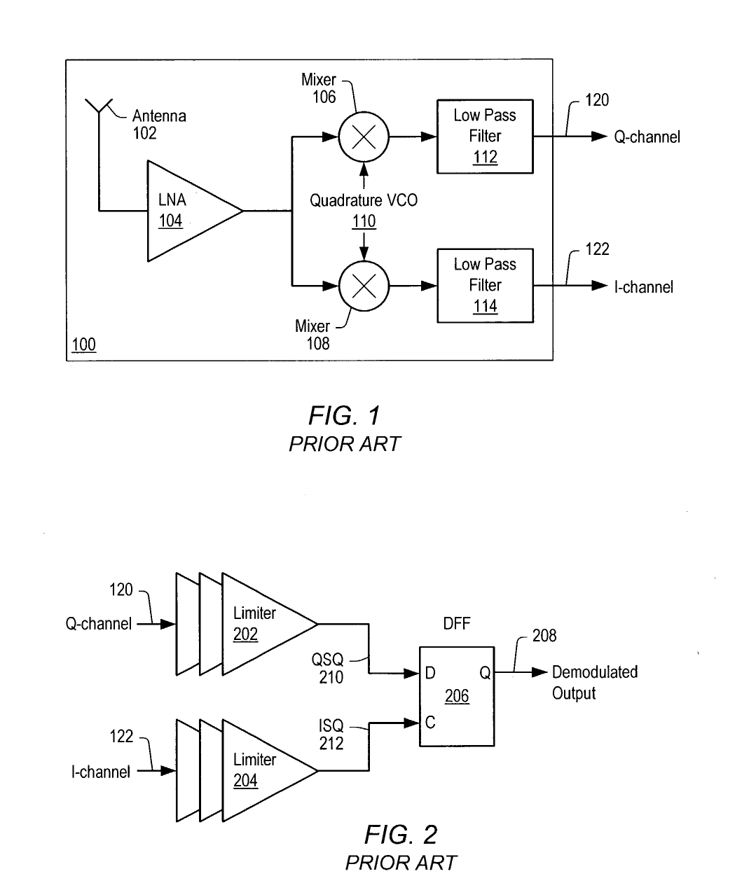

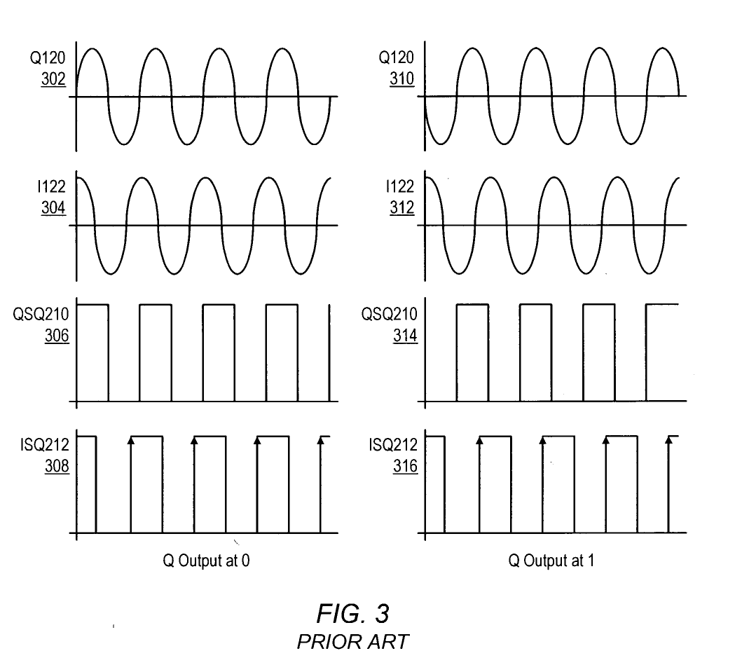

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “connected” means “directly or indirectly connected”, and the term “coupled” means “directly or indirectly connected”.

### DETAILED DESCRIPTION OF THE PREFERRED EMBODIMENTS

As used herein, a “trigger” signal is defined as a signal that is used to initiate, or “trigger”, an event or a sequence of events in a digital system. A trigger signal is said to be in a “triggering state” at a time when it initiates a desired event, or sequence of events. A periodic trigger signal may commonly be referred to as a “clock”. In a “synchronous” digital system, generally a clock, commonly referred to as a “system clock”, may be used for initiating most events, or sequences of events. An example of a triggering state may be, but is not limited to, a rising edge of a pulse of a clock in a synchronous digital system.

When an event, or a sequence of events, is said to be initiated “in response to” receiving a stimulus signal, it may be implied that the event, or the sequence of events, is initiated as a result of a combination of a trigger signal, used in triggering the event or sequence of events, being in a triggering state at a time when the stimulus signal is asserted. In one set of embodiments, the sending of a pulse through an output port may indicate a point in time at which a leading edge of the pulse occurs at the output port, and the receiving of a pulse through an input port may indicate a point in time at which a leading edge of the pulse occurs at the input port.

When referencing a pulse of a signal, a “leading edge” of the pulse is a first edge of the pulse, resulting from the value of the signal changing from a default value, and a “trailing edge” is a second edge of the pulse, resulting from the value of the signal returning to the default value. When data is said to be “registered” or “latched” “using” a signal, the signal acts as a trigger signal that controls the storing of the data into the register or latch. In other words, when a signal “used” for registering or latching data is in its triggering state, the data residing at respective input ports of the register or latch is stored into the register or latch. Similarly, when data is latched “on the leading edge” or “on the trailing edge” of a pulse of a clock, the data residing at respective input ports of a register or latch is stored into the register or latch, respectively, when a leading edge or a trailing edge of a pulse of the clock occurs, respectively.

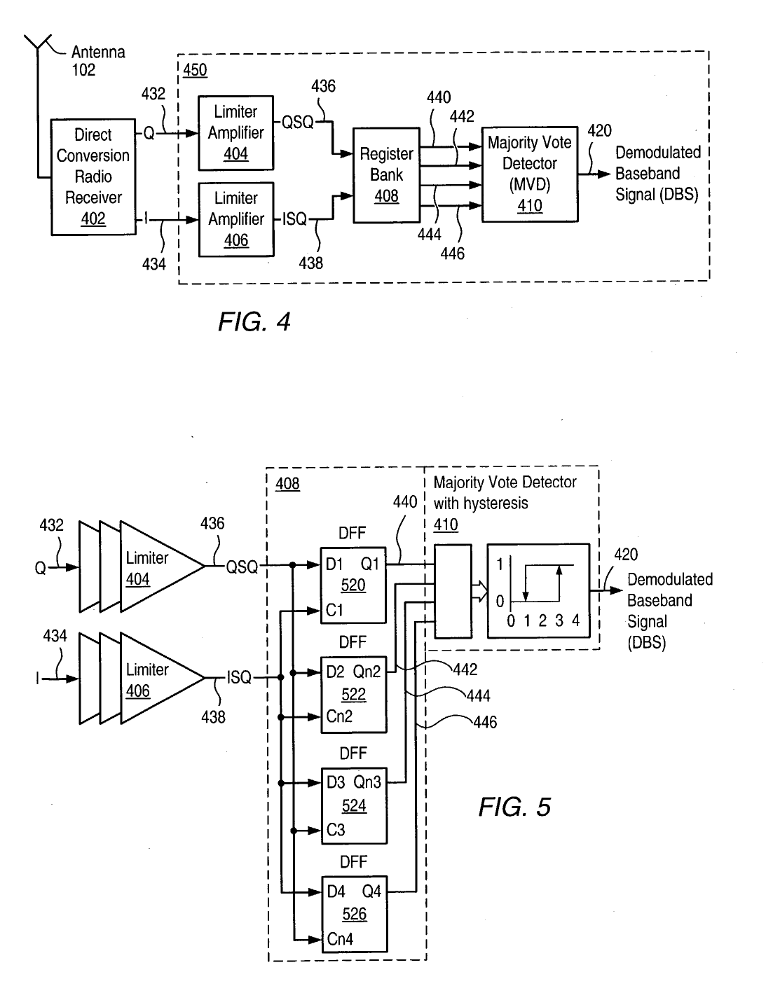

FIG. 4 is a block diagram of a radio receiver system containing an FSK demodulator 450 with improved spectral efficiency and improved modulation sensitivity implemented in accordance with one set of embodiments of the current invention. In this embodiment, a DCRR 402 provides Q 432 and I 434, which are coupled to limiter amplifiers 404 and 406, respectively. Limiter amplifier 404 may generate a rail-to-rail square wave version QSQ 436 of Q 432, and limiter amplifier 406 may generate a rail-to-rail square wave version ISQ 438 of I 434. QSQ 436 and ISQ 438 may be coupled to respective inputs of register bank 408. Register bank 408 may provide outputs 440, 442, 444 and 446, which may be connected to respective inputs of majority vote detector (MVD) 410. Depending on the number of registers in 408, the number of connections between 408 and MVD 410 may be more or less than those illustrated in FIG. 4. In one embodiment, an output of MVD 410 is demodulated baseband signal (DBS) 420.

FIG. 5 illustrates a more detailed diagram of FSK demodulator 450. One embodiment of register bank 408 comprises DFF 520, DFF 522, DFF 524, and DFF 526. In this embodiment, clock input Cn2 of DFF 522, clock input Cn4 of DFF 526, data output Qn2 of DFF 522, and data output Qn3 of DFF 524 are all asserted low, while the remaining clock inputs and data outputs of DFF 520, DFF 522, DFF 524 and DFF 526 are asserted high. QSQ 436 may be coupled to D1, D2, C3 and Cn4, and ISQ 438 may be coupled to D3, D4, C1 and Cn2, resulting in DFF 520, DFF 522, DFF 524 and DFF 526 being triggered at different edges of QSQ 436 and ISQ 438, respectively. DFF outputs 440, 442, 444 and 446 may each signal a demodulated bitstream separately. When more than two DFF outputs signal a “1”, a “1” may be assumed as the modulating value. Similarly, when more than two DFF outputs signal a “0”, a “0” may be assumed as the modulating value. In one embodiment, DBS 420 may remain unchanged until at least three DFF outputs signal a value different from the current value of DBS 420. Therefore, in this embodiment, MVD 410 incorporates hysteresis functionality.

In other words, in order for DBS 420 to change, MVD 410 may require a maximum of three counts. This requirement may be interpreted as a requirement of a total of three combined edges, either negative or positive, of QSQ 436 and ISQ 438. In order to insure the availability of three edges per bit, at least half a sine/cosine wave of Q 434 and I 434 per bit may be required, leading to a minimum modulation index of >1 that may be needed for FSK demodulator 450 to precisely demodulate a modulating bitstream. Therefore, FSK demodulator 450 may be twice as sensitive towards modulation as the single DFF FSK demodulator illustrated in FIG. 2. Carlson's rule predicts a bandwidth (BW) for a signal defined in terms of modulation index as:

BW≈2*(df+fm).

Therefore, for the prior art single DFF FSK demodulator in FIG. 2:

df/fm=2, thus BW≈2*(2*fm+fm)≈6*fm.

For the FSK demodulator implemented in accordance with one set of embodiments of the current invention, in FIG. 5:

df/fm=1, thus BW≈2*(fm+fm)≈4*fm.

This represents an effective spectral improvement of 1.5×.

Thus, various embodiments of the systems and methods described above may facilitate FSK demodulation performed without complex analog circuitry and without requiring processing power from a baseband digital signal processor (DSP), consuming minimal power, and performing baseband filtering through hysteresis while precisely demodulating a modulating bitstream at a minimum modulation index of df/fm>1.

Although the embodiments above have been described in considerable detail, other versions are possible. Numerous variations and modifications will become apparent to those skilled in the art once the above disclosure is fully appreciated. It is intended that the following claims be interpreted to embrace all such variations and modifications. Note the section headings used herein are for organizational purposes only and are not meant to limit the description provided herein or the claims attached hereto.

We claim:

1. A radio receiver system comprising:
a low-noise amplifier;
a frequency down converter stage coupled to the low-noise amplifier;
a filter stage coupled to the frequency down converter stage; and
an FSK demodulator coupled to the filter stage, wherein the FSK demodulator comprises:
a limiter stage, wherein the limiter stage is coupled to the filter stage; and
a register bank, wherein the register bank is coupled to the limiter stage;
wherein the FSK demodulator demodulates a modulating bit stream at a minimum modulation index of df/fm>1; and
wherein the FSK demodulator requires no additional analog circuitry.

2. The radio receiver system of claim 1, wherein the FSK demodulator further comprises a majority vote detector coupled to the register bank.

3. The radio receiver system of claim 2, wherein the majority vote detector performs post detection filtering through hysteresis.

4. The radio receiver system of claim 1, wherein the set of registers is a set of D flip-flops.

5. The radio receiver system of claim 1, wherein the frequency down converter stage comprises a quadrature VCO.

6. The radio receiver system of claim 5, wherein the frequency down converter stage further comprises a set of mixers.

7. The radio receiver system of claim 1, wherein the filter stage comprises a set of low pass filters.

8. The radio receiver system of claim 1, wherein the current consumed by the FSK demodulator is commensurate with the current consumed by the register bank.

9. The radio receiver system of claim 1, wherein the FSK demodulator requires no complex analog circuitry.

10. The radio receiver system of claim 1, wherein the FSK demodulator requires no processing power from a baseband DSP.

11. An FSK demodulator comprising:
a set of limiter amplifiers;
a register bank; and
a majority vote detector;
wherein the FSK demodulator is operable to demodulate signals I and Q obtained from a direct conversion radio receiver;
wherein the majority vote detector provides a baseband output representative of data carried by the I and Q signals;
wherein the FSK demodulator demodulates a modulating bit stream at a minimum modulation index of df/fm>1.

12. The FSK demodulator of claim 11;
wherein a first limiter amplifier in the set of limiter amplifiers is operable to receive the Q signal; and
wherein a second limiter amplifier in the set of limiter amplifiers is operable to receive the I signal.

13. The FSK demodulator of claim 12;
wherein the register bank comprises a first set of registers and a second set of registers;
wherein an output of the first limiter amplifier is coupled to a respective data input of each register in the first set of registers and to a respective clock input of each register in the second set of registers,
wherein an output of the second limiter amplifier is coupled to a respective data input of each register in the second set of registers and to a respective clock input of each register in the first set of registers; and
wherein each register in the register bank triggers at different edges of the I signal and the Q signal.

14. The FSK demodulator of claim 13, wherein an output of each register in the register bank is coupled to a respective input of the majority vote detector.

15. The FSK demodulator of claim 11, wherein the set of registers is a set of D flip-flops.

16. The FSK demodulator of claim 11, wherein the current consumed by the FSK demodulator is commensurate with the current consumed by the register bank.

17. The FSK demodulator of claim 11;
wherein the FSK demodulator requires no complex analog circuitry; and
wherein the FSK demodulator requires no processing power from a baseband DSP.

18. A method for FSK demodulation, the method comprising:
receiving a Q signal and an I signal;
amplifying the Q signal and the I signal, resulting in an amplified Q signal and an amplified I signal;
setting a state for each register in a register bank, wherein the amplified Q signal and the amplified I signal are selectively coupled to a respective data input and a respective clock input of each register in the register bank;
receiving a respective register output from each register in the register bank; and
computing a baseband output from the received respective register outputs;
wherein the baseband output represents a demodulated modulating bit stream at a minimum modulation index of df/fm>1.

19. The method of claim 18, wherein said receiving the Q signal and the I signal comprises receiving the Q signal and the I signal from a direct conversion radio receiver.

20. The method of claim 18, wherein said amplifying the Q signal and the I signal comprises:
converting the Q signal to a rail to rail square wave signal; and
converting the I signal to a rail to rail square wave signal.

21. The method of claim 18, wherein said register bank comprises D flip-flops.

22. The method of claim 18, wherein said computing the baseband output comprises taking a majority vote of the received respective register outputs.

23. The method of claim 18;
wherein said computing the baseband output comprises post-detection filtering; and
wherein said post detection filtering is accomplished through hysteresis.
